(19) United States
(12) Patent Application Publication
(10) Pub. No.: US 2007/0174887 A1
(43) Pub. Date: Jul. 26, 2007

(54) Interactive mobile wireless digital TV

(76) Inventors: Lehong Hu, San Jose, CA (US); Eric Yam, San Diego, CA (US)

Correspondence Address: ROGITZ & ASSOCIATES, 750 B STREET, SUITE 3120, SAN DIEGO, CA, 92101, US

(21) Appl. No.: 11/403,031

(22) Filed: Apr. 12, 2006

Related U.S. Application Data
(60) Provisional application No. 60/761,731, filed on Jan. 23, 2006.

(51) Int. Cl. H04N 7/173; H04N 7/16

(52) U.S. Cl. 725/112; 725/100; 725/62; 725/110; 725/113

(57) ABSTRACT

A wireless telephone receives DTV signals over a wireless telephony carrier network in ISDB, DMB, DVB-H, MediaFlo™, and the like for presentation of TV programming on the display of the telephone. The user can input signals to interact with the TV programming, and the user signals are wirelessly transmitted using a non-telephony network such as WiFi, WiMax, or wireless Ethernet.

This application claims priority to U.S. provisional patent application Ser. No. 60/761,731, filed Jan. 23, 2006.

### I. FIELD OF THE INVENTION

The present invention relates generally to digital televisions (DTV).

### II. BACKGROUND OF THE INVENTION

TV content can be provided to mobile telephones using telecom-centric standards such as Integrated Services Digital Broadcasting (ISDB), Digital Multimedia Broadcast (DMB), Digital Video Broadcasting (DVB-H), and MediaFLO™ over a wireless telephony network such as a GSM or CDMA network. As understood herein, not only do consumers wish to view TV on their wireless phones, but they also wish to interact with TV shows. The present invention recognizes that such interactivity not only is desired by consumers, but also allows consumers to click deeply into ads to order products, benefitting content providers. As further recognized herein, there are situations in which the telephony carrier's support is not available or is not desired for receiving user interaction. The present invention understands that non-telephony wireless networks such as Wireless Fidelity (WiFi), Worldwide Interoperability for Microwave Access (the IEEE 802.16 standard colloquially known as “WiMax”), and wireless Ethernet are available non-telecom carrier networks that can be used to provide the above-mentioned interaction with TV programming.

### SUMMARY OF THE INVENTION

A method for providing TV programming includes sending TV signals to a wireless TV device over a wireless telephony network, and at the device, receiving user input representative of user interaction with a TV program associated with the TV signals. The method also includes wirelessly transmitting signals representative of the user input from the device over a non-telephony wireless network. In non-limiting implementations the TV signals may be digital TV signals and the device can be portable.

In non-limiting embodiments the TV signals may be received over the telephony network using Integrated Services Digital Broadcasting (ISDB). In other embodiments the TV signals may be received over the telephony network using Digital Multimedia Broadcast (DMB), or using Digital Video Broadcasting (DVB-H), or using a CDMA DTV protocol such as, e.g., MediaFlo™. In contrast, the non-telephony wireless network may include a Wireless Fidelity (WiFi) network, or a Worldwide Interoperability for Microwave Access (WiMax) network, or a wireless Ethernet network.

In another aspect, a wireless telephone includes a housing holding a wireless DTV receiver that receives DTV signals in Integrated Services Digital Broadcasting (ISDB), Digital Multimedia Broadcast (DMB), Digital Video Broadcasting (DVB-H), or a CDMA-centric digital broadcasting protocol. A video display on the housing displays the DTV signals. The housing also contains a processor for receiving user input signals and causing the user input signals to be wirelessly transmitted using Wireless Fidelity (WiFi), Worldwide Interoperability for Microwave Access (WiMax), or wireless Ethernet.

In still another aspect, a processor includes means for receiving DTV signals from a wireless telephone carrier network, and means for causing the DTV signals to be displayed on a video display. Further, the processor includes means for receiving user signals representing user interaction with programming represented by the DTV signals. Means are provided for causing the wireless transmission of signals representing user interaction over a wireless network that is not a wireless telephone carrier network.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of the present interactive mobile wireless digital television (DTV); and

FIG. 2 is a flow chart of a non-limiting example of the logic that may be implemented in whole or in part by logic circuitry within the processor the wireless telephone.

### DETAILED DESCRIPTION OF THE PREFERRED EMBODIMENT

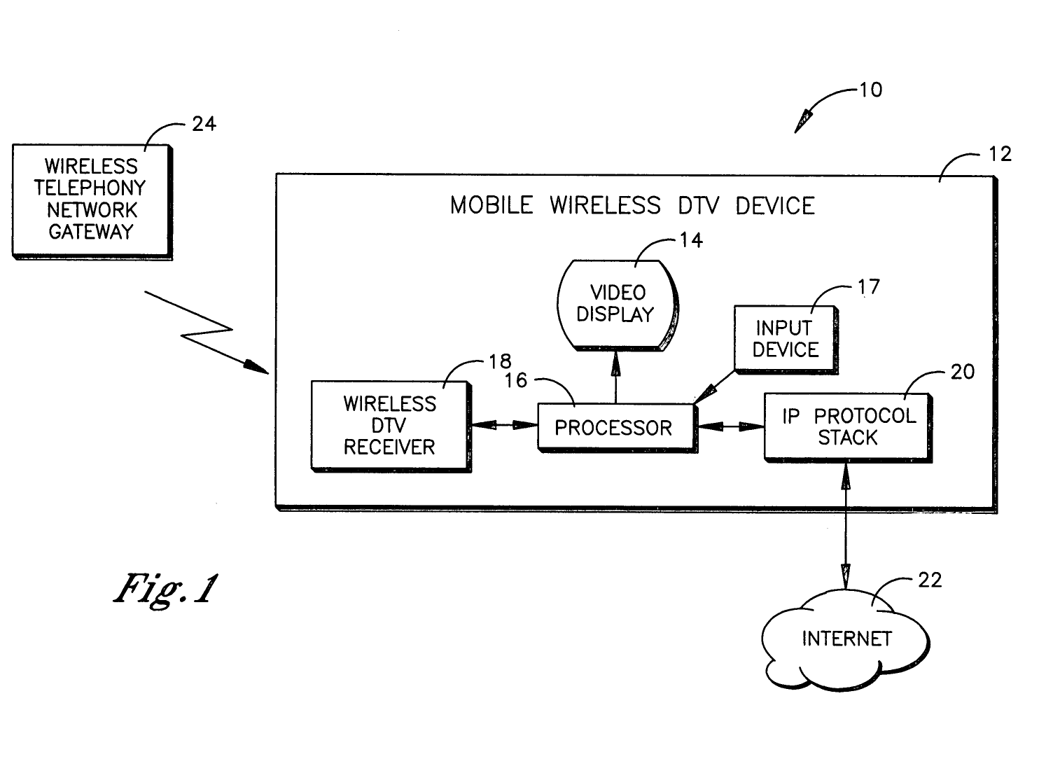

Referring initially to FIG. 1, a mobile wireless digital television (DTV) device such as a wireless telephone is shown, generally designated 10. The device 10 may include a portable lightweight housing 12 that supports a multimedia (video and/or audio) display 14 that displays data sent to it from a processor 16. This data may include user-input signals from an input device 17 such as but not limited to a keypad and also may include multimedia signals from a wireless DTV receiver 18 that communicates with the processor 16 as shown. Also, the processor 16 communicates with an Internet Protocol (IP) stack 20 to facilitate wireless communication in accordance with disclosure below with the Internet 22. Wireless communication is also afforded by means of the wireless DTV receiver 18 with a gateway 24 of a wireless telephony network such as but not limited to a code division multiple access (CDMA) network or Global System for Mobile Communication (GSM) network. Accordingly, the skilled artisan will now recognize that the device 10 can communicate with a wireless telephony network owned by a telephone carrier to receive DTV signals at the receiver 18, and can also communicate with a non-telephony network using the IP stack 20.

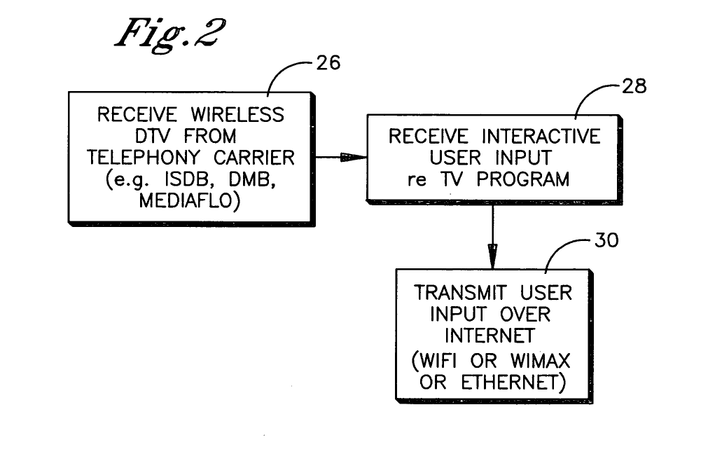

With the above architecture of a preferred non-limiting device 10 in mind, attention is now directed to FIG. 2 for an illustration of one non-limiting way in which the device 10 can operate. Commencing at block 26, DTV signals are received from the telephony carrier network (e.g., from the gateway 24) at the receiver 18 and thence at the processor 16 in an appropriate format. In some implementations the TV signals are received using Integrated Services Digital Broadcasting (ISDB) protocol. In other implementations the TV signals can be received using Digital Multimedia Broadcast (DMB) or Digital Video Broadcasting (DVB-H). In still other implementations the TV signals may be received using a CDMA-oriented DTV protocol such as MediaFlo™. The processor 16 causes the signals to be displayed on the display 14.

To make it possible for TV programs to build value added applications and services such as gaming, voting, polling, shopping, product recommendations, advertising, instant messaging, etc. without resort to the telecom carrier's network, user input from the input device 17 that can pertain to interactivity with a TV program being displayed on the display 14 may be wirelessly transmitted through the IP protocol stack 20 to the Internet 22. The IP protocol stack 20 may include a transmission control protocol/Internet protocol (TCP/IP) connection with Wireless Fidelity (WiFi), Worldwide Interoperability for Microwave Access (WiMax), or wireless Ethernet as the physical layer, thus providing a communication channel for Internet based interaction without using a telephone carrier's network. In turn, a server associated with the broadcaster of the TV program being viewed on the display 14 can receive the interactive signals through the Internet.

While the particular INTERACTIVE MOBILE WIRELESS DIGITAL TV as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for providing TV programming, comprising:
sending TV signals to a wireless TV device over a wireless telephony network;
at the device, receiving user input representative of user interaction with at least one TV program associated with the TV signals; and
wirelessly transmitting signals representative of the user input from the device over a non-telephony wireless network.

2. The method of claim 1, wherein the TV signals are digital TV signals, and the device is portable.

3. The method of claim 1, wherein the TV signals are received using Integrated Services Digital Broadcasting (ISDB).

4. The method of claim 1, wherein the TV signals are received using Digital Multimedia Broadcast (DMB).

5. The method of claim 1, wherein the TV signals are received using Digital Video Broadcasting (DVB-H).

6. The method of claim 1, wherein the TV signals are received using a CDMA DTV protocol.

7. The method of claim 1, wherein the non-telephony wireless network includes a Wireless Fidelity (WiFi) network.

8. The method of claim 1, wherein the non-telephony wireless network includes a Worldwide Interoperability for Microwave Access (WiMax) network.

9. The method of claim 1, wherein the non-telephony wireless network includes a wireless Ethernet network.

10. A wireless telephone, comprising:
a housing;
at least one wireless DTV receiver in the housing and receiving DTV signals in at least one of the protocols in the group consisting of Integrated Services Digital Broadcasting (ISDB), Digital Multimedia Broadcast (DMB), Digital Video Broadcasting (DVB-H), and a CDMA-centric digital broadcasting protocol;
a display supported on the housing for displaying the DTV signals; and
at least one processor in the housing and receiving user input signals, the processor causing the user input signals to be wirelessly transmitted using at least one of the protocols in the group consisting of Wireless Fidelity (WiFi), Worldwide Interoperability for Microwave Access (WiMax), and wireless Ethernet.

11. The wireless telephone of claim 10, wherein the DTV signals are received using Integrated Services Digital Broadcasting (ISDB).

12. The wireless telephone of claim 10, wherein the DTV signals are received using Digital Multimedia Broadcast (DMB).

13. The wireless telephone of claim 10, wherein the DTV signals are received using Digital Video Broadcasting (DVB-H).

14. The wireless telephone of claim 10, wherein the DTV signals are received using a CDMA-centric protocol.

15. The wireless telephone of claim 10, wherein the user input signals are transmitted using a Wireless Fidelity (WiFi) network.

16. The wireless telephone of claim 10, wherein the user input signals are transmitted using a Worldwide Interoperability for Microwave Access (WiMax) network.

17. The wireless telephone of claim 10, wherein the user input signals are transmitted using a wireless Ethernet network.

18. A processor comprising:
means for receiving DTV signals from a wireless telephone carrier network;
means for causing the DTV signals to be displayed on a video display;
means for receiving user signals representing user interaction with programming represented by the DTV signals; and
means for causing the wireless transmission of signals representing user interaction with programming represented by the DTV signals over a wireless network that is not a wireless telephone carrier network.

19. The processor of claim 18, wherein the means for receiving receives DTV signals in at least one of the protocols in the group consisting of Integrated Services Digital Broadcasting (ISDB), Digital Multimedia Broadcast (DMB), Digital Video Broadcasting (DVB-H), and a CDMA-centric digital broadcasting protocol.

20. The processor of claim 19, wherein the means for wirelessly transmitting transmits signals representing user interaction with programming using at least one of the protocols in the group consisting of Wireless Fidelity (WiFi), Worldwide Interoperability for Microwave Access (WiMax), and wireless Ethernet.
